(19) United States
(12) Patent Application Publication
(10) Pub. No.: US 2014/0124345 A1
(43) Pub. Date: May 8, 2014

(54) SCISSORS-TYPE CONNECTING MEMBER

(71) Applicant: PRIMAX ELECTRONICS LTD., Taipei (TW)

(72) Inventor: Chin-Siong Khor, Neihu, Taipei (TW)

(73) Assignee: PRIMAX ELECTRONICS LTD., Taipei (TW)

(21) Appl. No.: 13/670,206

(22) Filed: Nov. 6, 2012

(51) Int. Cl. H01H 13/14

(52) U.S. Cl. 200/344

(57) ABSTRACT

A scissors-type connecting member includes an inner frame and an outer frame. The inner frame includes a pivot rod. The pivot rod includes a curved edge and two flat slant surfaces. The outer frame includes a pivot hole, an entrance, and a guiding surface. The pivot hole has a flat bottom surface. The entrance is located beside the pivot hole. The guiding surface is disposed under the entrance. For assembling the scissors-type connecting member, the pivot rod of the inner frame is moved into the pivot hole along the guiding surface. When the inner frame is rotated relative to the outer frame, the two flat slant surfaces of the pivot rod are respectively stopped by the bottom surface of the pivot hole and the guiding surface. Consequently, a rotating angle of the inner frame relative to the outer frame is limited.

### FIELD OF THE INVENTION

The present invention relates to a scissors-type connecting member, and more particularly to a scissors-type connecting member for a key structure of a keyboard.

### BACKGROUND OF THE INVENTION

Nowadays, consumer electronic products have experienced great growth and are now rapidly gaining in popularity. Especially, notebook computers have become dispensable electronic products of the office workers.

The notebook computer comprises a keyboard with plural key structures. Generally, a key structure of the keyboard of the notebook computer mainly comprises a scissors-type connecting member, an elastic element, and a keycap. The elastic element is disposed within the scissors-type connecting member. The keycap is disposed over the scissors-type connecting member and the elastic element. Typically, the scissors-type connecting member comprises an inner frame and an outer frame. Hereinafter, the configurations of a conventional scissors-type connecting member will be illustrated with reference to FIGS. 1, 2 and 3. FIG. 1 is a schematic perspective view illustrating a conventional scissors-type connecting member. FIG. 2 is a schematic perspective view illustrating an outer frame of the conventional scissors-type connecting member of FIG. 1. FIG. 3 is a schematic perspective view illustrating an inner frame of the conventional scissors-type connecting member of FIG. 1.

As shown in FIGS. 1, 2 and 3, the scissors-type connecting member 1 comprises an inner frame 11 and an outer frame 12. A circular pivot hole 121 is formed in an inner surface of the outer frame 12. A pivot rod 111 is protruded from an outer surface of the inner frame 11. For assembling the scissors-type connecting member 1, the pivot rod 111 of the inner frame 11 is inserted into the pivot hole 121 of the outer frame 12, so that the inner frame 11 is pivotally coupled to the outer frame 12.

The conventional scissors-type connecting member 1, however, still has some drawbacks. For example, the inner frame 11 and the outer frame 12 are pivotally coupled to each other through the pivot rod 111. Since the scissors-type connecting member 1 is not equipped with a position-limiting structure, the inner frame 11 may be rotated relative to the outer frame 12 at any rotating angle. The absence of the position-limiting structure is detrimental to the connection between the keycap and the scissors-type connecting member 1. That is, the scissors-type connecting member 1 is readily connected with the keycap in a wrong direction.

Moreover, the inner frame 11 and the outer frame 12 of the conventional scissors-type connecting member 1 fail to be directly combined together. That is, for combining the inner frame 11 with the outer frame 12, the outer frame 12 should be manually widened and subjected to a tiny deformation. After the outer frame 12 is widened, the pivot rod 111 of the inner frame 11 can be inserted into the pivot hole 121 of the outer frame 12. Under this circumstance, since the assembling time is increased, the throughput of the keyboard is reduced. Moreover, it is unable to automatically assemble the scissors-type connecting member 1.

Therefore, there is a need of providing an improved scissors-type connecting member in order to eliminate the above drawbacks.

### SUMMARY OF THE INVENTION

The present invention provides a scissors-type connecting member. The scissors-type connecting member can be assembled quickly and automatically. Moreover, in the scissors-type connecting member of the present invention, the rotating angle of the inner frame relative to the outer frame can be limited.

In accordance with an aspect of the present invention, there is provided a scissors-type connecting member. The scissors-type connecting member includes an inner frame and an outer frame. The inner frame includes a pivot rod. The outer frame includes a mounting part, wherein the mounting part includes an entrance and a pivot hole. After the pivot rod of the inner frame is introduced into the pivot hole through the entrance, the inner frame is pivotally coupled to the outer frame, and the pivot rod and the pivot hole interfered with each other to limit a rotating angle of the inner frame relative to the outer frame.

In an embodiment, the outer frame further includes an outer frame body, wherein the mounting part is disposed on an inner surface of the outer frame body.

In an embodiment, the mounting part further includes a guiding surface, which is extended downwardly from a first side of the entrance and located beside the pivot hole. A bottom surface of the pivot hole is a flat surface. A top surface of the pivot hole is a curved surface. The bottom surface of the pivot hole is connected with the guiding surface.

In an embodiment, the inner frame further includes an inner frame body. The pivot rod is disposed on an outer surface of the inner frame body. The pivot rod includes a curved edge and two flat slant surfaces. The two flat slant surfaces are respectively extended from two opposite sides of the curved edge and symmetrical to each other. After the pivot rod is introduced into the pivot hole, the curved edge is contacted with the top surface of the pivot hole.

In an embodiment, after the pivot rod is introduced into the pivot hole, the two flat slant surfaces of the pivot rod are respectively stopped by the bottom surface of the pivot hole and the guiding surface, so that the bottom surface of the pivot hole and the guiding surface interfere with the two flat slant surfaces to limit the rotating angle of the inner frame relative to the outer frame.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a conventional scissors-type connecting member;

FIG. 2 is a schematic perspective view illustrating an outer frame of the conventional scissors-type connecting member of FIG. 1;

FIG. 3 is a schematic perspective view illustrating an inner frame of the conventional scissors-type connecting member of FIG. 1;

FIG. 4 is a schematic perspective view illustrating an inner frame of a scissors-type connecting member according to an embodiment of the present invention;

FIG. 5 is a schematic side view illustrating the inner frame of the scissors-type connecting member of FIG. 4;

FIG. 6 is a schematic perspective view illustrating an outer frame of the scissors-type connecting member according to the embodiment of the present invention;

FIG. 7 is a schematic section view illustrating the outer frame of the scissors-type connecting member of FIG. 6;

FIG. 8 schematically illustrates a process of assembling the scissors-type connecting member according to the embodiment of the present invention; and

FIG. 9 is a schematic assembled view illustrating the scissors-type connecting member according to the embodiment of the present invention.

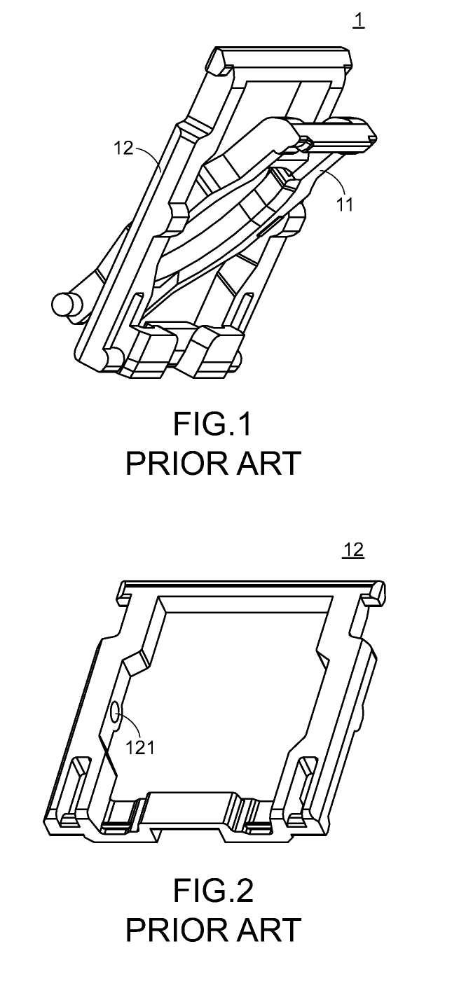

### DETAILED DESCRIPTION OF THE PREFERRED EMBODIMENT

The present invention provides a scissors-type connecting member for a key structure of a keyboard.

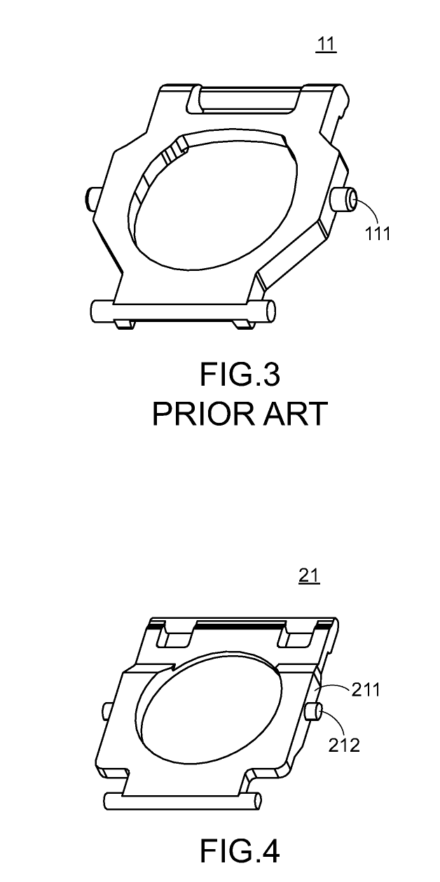

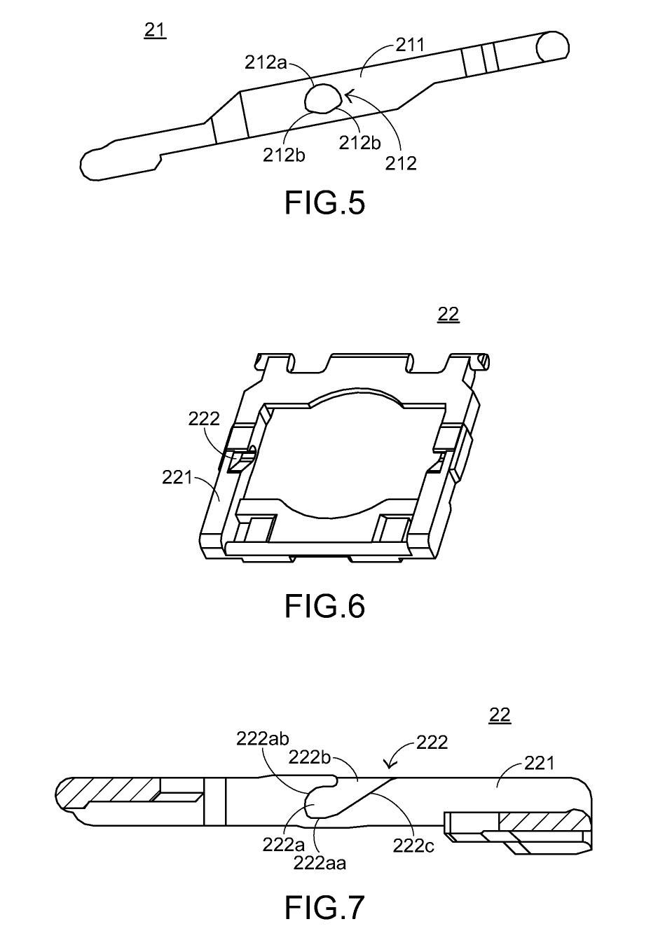

Hereinafter, the configurations of a scissors-type connecting member of the present invention will be illustrated with reference to FIGS. 4-7. FIG. 4 is a schematic perspective view illustrating an inner frame of a scissors-type connecting member according to an embodiment of the present invention. FIG. 5 is a schematic side view illustrating the inner frame of the scissors-type connecting member of FIG. 4. FIG. 6 is a schematic perspective view illustrating an outer frame of the scissors-type connecting member according to the embodiment of the present invention. FIG. 7 is a schematic section view illustrating the outer frame of the scissors-type connecting member of FIG. 6.

First of all, the components of the scissors-type connecting member will be illustrated. The scissors-type connecting member 2 comprises an inner frame 21 and an outer frame 22.

As shown in FIGS. 4 and 5, the inner frame 21 comprises an inner frame body 211 and a pivot rod 212. The pivot rod 212 is protruded from an outer surface of the inner frame body 211. The pivot rod 212 comprises a curved edge 212a and two flat slant surfaces 212b. The two flat slant surfaces 212b are extended from two opposite sides of the curved edge 212a, respectively. Moreover, the two flat slant surfaces 212b intersect with each other. In addition, the two flat slant surfaces 212b are symmetrical to each other.

As shown in FIGS. 6 and 7, the outer frame 22 comprises an outer frame body 221 and a mounting part 222. The mounting part 222 is disposed on an inner surface of the outer frame body 221. In addition, the mounting part 222 comprises a pivot hole 222a, an entrance 222b, and a guiding surface 222c.

In particular, a bottom surface 222aa of the pivot hole 222a is a flat surface, and a top surface 222ab of the pivot hole 222a is a curved surface. The guiding surface 222c is disposed under the entrance 222b, and located beside the pivot hole 222a. In addition, the guiding surface 222c is extended downwardly from a first side of the entrance 222b, and connected with the bottom surface 222aa of the pivot hole 222a.

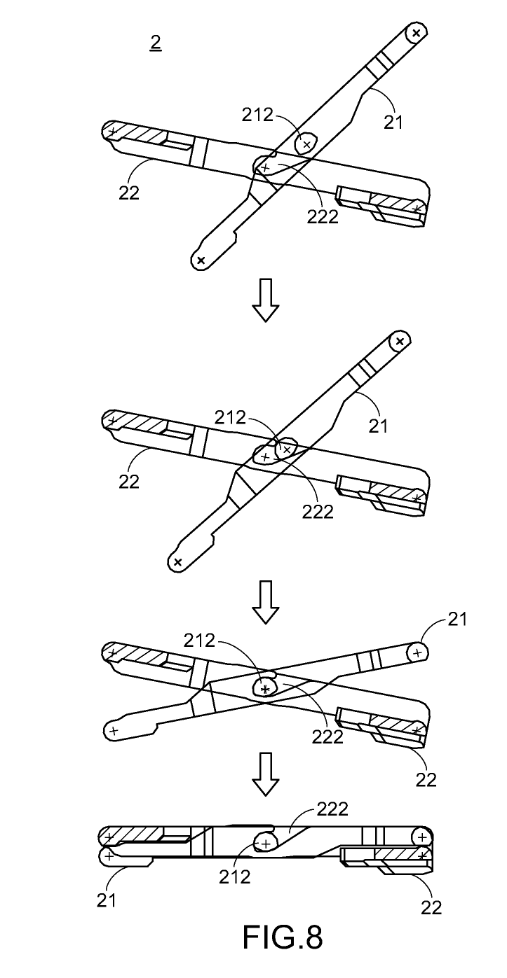

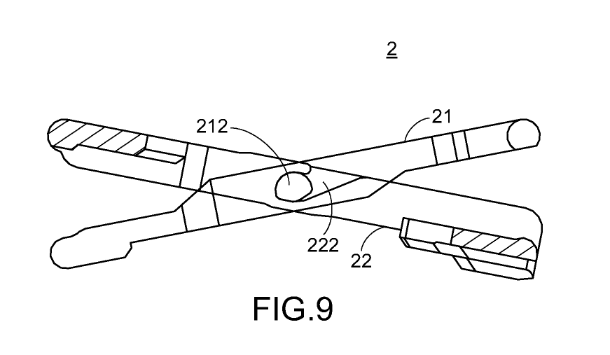

Hereinafter, a sequence of assembling the scissors-type connecting member 2 of the present invention will be illustrated with reference to FIGS. 4-9. FIG. 8 schematically illustrates a process of assembling the scissors-type connecting member according to the embodiment of the present invention. FIG. 9 is a schematic assembled view illustrating the scissors-type connecting member according to the embodiment of the present invention.

For assembling the scissors-type connecting member 2, the pivot rod 212 of the inner frame 21 is firstly transferred through the entrance 222b of the outer frame 22 and then introduced into the pivot hole 222a, so that the inner frame 21 is pivotally coupled to the inner surface of the outer frame 22. The assembling process will be illustrated in more details as follows.

Firstly, the curved edge 212a of the pivot rod 212 and one of the two flat slant surfaces 212b are transferred through the entrance 222b. At the same time, the flat slant surface 212b is contacted with the guiding surface 222c under the entrance 222b, and the curved edge 212a is contacted with a second side of the entrance 222b. The flat slant surface 212b of the pivot rod 212 is continuously moved into the pivot hole 222a along the guiding surface 222c, and then contacted with the bottom surface 222aa of the pivot hole 222a. Meanwhile, the curved edge 212a is also contacted with the top surface 222ab of the pivot hole 222a.

Under this circumstance, the inner frame 21 is pivotally coupled to the inner surface of the outer frame 22, and the inner frame 21 is rotatable relative to the outer frame 22.

Moreover, during the process of combining the inner frame 21 with the outer frame 22, in response to a downward force exerted on the inner frame 21, the second side of the entrance 222b is pushed by the curved edge 212a. Consequently, the second side of the entrance 222b is subjected to a tiny deformation. Due to the tiny deformation, the pivot rod 212 can be introduced into the pivot hole 222a.

After the pivot rod 212 is introduced into the pivot hole 222a, the inner frame 21 is rotatable relative to the outer frame 22. As the inner frame 21 is rotated, the two flat slant surfaces 212b of the pivot rod 212 are respectively stopped by the bottom surface 222aa of the pivot hole 222a and the guiding surface 222c beside the pivot hole 222a, and the curved edge 212a is continuously contacted with the top surface 222ab of the pivot hole 222a. Since the bottom surface 222aa of the pivot hole 222a and the guiding surface 222c beside the pivot hole 222a interfere with the two flat slant surfaces 212b, the rotating angle of the inner frame 21 relative to the outer frame 22 is limited.

From the above descriptions, the present invention provides a scissors-type connecting member. In the scissors-type connecting member 2 of the present invention, the entrance 222b is located beside the pivot hole 222a, and the inclined guiding surface 222c is disposed under the entrance 222b. Consequently, during the process of assembling the scissors-type connecting member 2, the pivot rod 212 of the inner frame 21 can be easily inserted into the pivot hole 222a of the outer frame 22.

Moreover, since the bottom surface 222aa of the pivot hole 222a and the guiding surface 222c beside the pivot hole 222a interfere with the two flat slant surfaces 212b, the inner frame 21 is only rotatable relative to the outer frame 22 in a single direction at a limited rotating angle.

In comparison with the conventional scissors-type connecting member, the inner frame of the scissors-type connecting member of the present invention can be quickly installed on the outer frame. Consequently, the scissors-type connecting member of the present invention can be assembly automatically. Moreover, the rotating angle of the inner frame relative to the outer frame is limited. Consequently, during the process of assembling a key structure, the scissors-type connecting member and the cap are combined with each other in only a specified direction. Under this circumstance, the overall working efficiency is enhanced, and the possibility of erroneously assembling the key structure is largely reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A scissors-type connecting member, comprising:
an inner frame comprising a pivot rod; and
an outer frame comprising a mounting part, wherein said mounting part comprises an entrance and a pivot hole,
wherein after said pivot rod of said inner frame is introduced into said pivot hole through said entrance, said inner frame is pivotally coupled to said outer frame, and said pivot rod and said pivot hole interfered with each other to limit a rotating angle of said inner frame relative to said outer frame.

2. The scissors-type connecting member according to claim 1, wherein said outer frame further comprises an outer frame body, wherein said mounting part is disposed on an inner surface of said outer frame body.

3. The scissors-type connecting member according to claim 1, wherein said mounting part further comprises a guiding surface, which is extended downwardly from a first side of said entrance and located beside said pivot hole, wherein a bottom surface of said pivot hole is a flat surface, and a top surface of said pivot hole is a curved surface, wherein said bottom surface of said pivot hole is connected with said guiding surface.

4. The scissors-type connecting member according to claim 3, wherein said inner frame further comprises an inner frame body, and said pivot rod is disposed on an outer surface of said inner frame body, wherein said pivot rod comprises a curved edge and two flat slant surfaces, and said two flat slant surfaces are respectively extended from two opposite sides of said curved edge and symmetrical to each other, wherein after said pivot rod is introduced into said pivot hole, said curved edge is contacted with said top surface of said pivot hole.

5. The scissors-type connecting member according to claim 4, wherein after said pivot rod is introduced into said pivot hole, said two flat slant surfaces of said pivot rod are respectively stopped by said bottom surface of said pivot hole and said guiding surface, so that said bottom surface of said pivot hole and said guiding surface interfere with said two flat slant surfaces to limit said rotating angle of said inner frame relative to said outer frame.
